(19) United States
(12) Patent Application Publication
(10) Pub. No.: US 2016/0120160 A1
(43) Pub. Date: May 5, 2016

(54) Switchblade soft plastic lure

(71) Applicant: Michael Penn, Odessa, TX (US)

(72) Inventor: Michael Penn, Odessa, TX (US)

(21) Appl. No.: 14/121,694

(22) Filed: Oct. 30, 2014

(51) Int. Cl. A01K 85/02; A01K 83/06

(52) U.S. Cl. CPC A01K 85/02; A01K 83/06

(57) ABSTRACT

Some embodiments provide a fishing lure that increases the ratio of positive hook settings by moving a hook along a hook set pathway within the mouth of a fish when a fishing line to which the hook is attached is pulled taught. The fishing lure comprises a lure body and a hook with an attached retaining bead. The retaining bead holds the hook inside the fishing lure's hook pocket until sufficient force is applied to the fishing line and hook while a counterforce is applied to the lure body. In some embodiments, the lure body is a soft plastic artificial fishing lure body. Upon setting the hook, the hook moves up out of and away from the lure body, and therefore is not obstructed by the lure body.

### BACKGROUND

Fishing is a common leisure sport. Perhaps the most common leisure fishing is performed with a rod and reel. Typically, a person uses bait with a hook in order to catch fish. For example live bait or artificial lures can be used to attract fish to the fish hook, whereby the hook is able to snag the mouth of the fish when the fish attempts to eat the bait. Even among the different types of bait, several sub-categories exist to allow people who fish using a rod and reel (hereafter referred to as “anglers”) to choose the right bait for the fishing conditions. Artificial fishing lures, for example, can be hard (e.g., wood, metal, hard plastic) or soft (e.g., rubbery, soft plastic, etc.). One problem with larger soft plastic lures is that the amount of fish bites that result in a positive catch of the fish is lower than many anglers would like. This is because the hook does not always snag inside the fish's mouth (hereafter referred to as “hook set”). Unfortunately, current products in this line have a poor ratio of positive hook sets. With lures of this type, the bulk of the soft plastic stays in the hook setting area which often prevents a good hook set. Moreover, the majority of larger soft plastic lures do not move away from the hook point, causing overall interference with setting the hook, and thus decreasing the number of positive hook sets.

Thus, what is needed is a soft plastic fishing lure that provides weedless operation so as not to get tangled up in weeds and other underwater items and which provides a hook setting which when initiated reduces obstructions from the body of the lure and results in an increase in the hook set ratio.

### BRIEF SUMMARY

Some embodiments of the invention provide a novel fishing lure that increases the ratio of positive hook settings by moving a hook along a hook set pathway within the mouth of a fish when a fishing line to which the hook is attached is pulled taught. In some embodiments, the fishing lure comprises a lure body and a hook with an attached retaining bead. The retaining bead is attached to the hook at a position when first curved portion of the hook meets a second straight portion of the hook. The lure body of some embodiments comprises an interior hook pocket and a nose tube. The hook set pathway comprises a first hook location within the interior hook pocket of the lure body in which the hook and retaining bead reside prior to setting the hook to the mouth of the fish and a second hook location protruding out from the lure body when setting the hook to the mouth of the fish. In some embodiments, the lure body is a soft plastic artificial fishing lure body. Upon setting the hook, the hook moves up out of and away from the lure body and therefore is not obstructed by the lure body.

In some embodiments, the fishing lure is weighted. The weighted fishing lure of some embodiments comprises a lure body and a hook with a retaining weight. The lure body of some embodiments comprises an interior hook pocket and a weight pocket. The hook set pathway comprises a first set of hook loading locations comprising the interior hook pocket of the lure body for the hook and the weight pocket for the retainer weight and a second set of hook setting locations comprising any of a plurality of locations protruding out from the lure body when setting the hook to the mouth of the fish.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments found in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matters can be embodied in other specific forms without departing from the spirit of the subject matters.

### BRIEF DESCRIPTION OF THE DRAWINGS

Having thus described the invention in general terms, reference is now being made to the accompanying drawings, which are not necessarily drawn to scale, and which show different views of different example embodiments, and wherein:

FIG. 1 conceptually illustrates an example of a lure currently being marketed that has a poor ratio of positive hook settings in some embodiments.

FIG. 2 conceptually illustrates the proposed fishing lure that increases the ratio of positive hook settings in some embodiments.

FIG. 3 conceptually illustrates the proposed weighted fishing lure that increases the ratio of positive hook settings in some embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for numerous lure body shapes and fishing applications.

Some embodiments of the invention provide a novel fishing lure that increases the hook set ratio by moving a hook along a hook set pathway within the mouth of a fish when a fishing line to which the hook is attached is pulled taught. In some embodiments, the fishing lure comprises a lure body and a hook with a retaining bead. The retaining bead is attached to the hook at a position when first curved portion of the hook meets a second straight portion of the hook. The lure body of some embodiments comprises an interior hook pocket and a nose tube. The hook set pathway comprises a first hook location within the interior hook pocket of the lure body at which the hook and retaining bead reside prior to setting the hook to the mouth of the fish and a second hook location protruding out from the lure body when setting the hook to the mouth of the fish. In some embodiments, the lure body is a soft plastic artificial fishing lure body. Upon setting the hook, the hook moves out of and away from the lure body and therefore is not obstructed by the lure body.

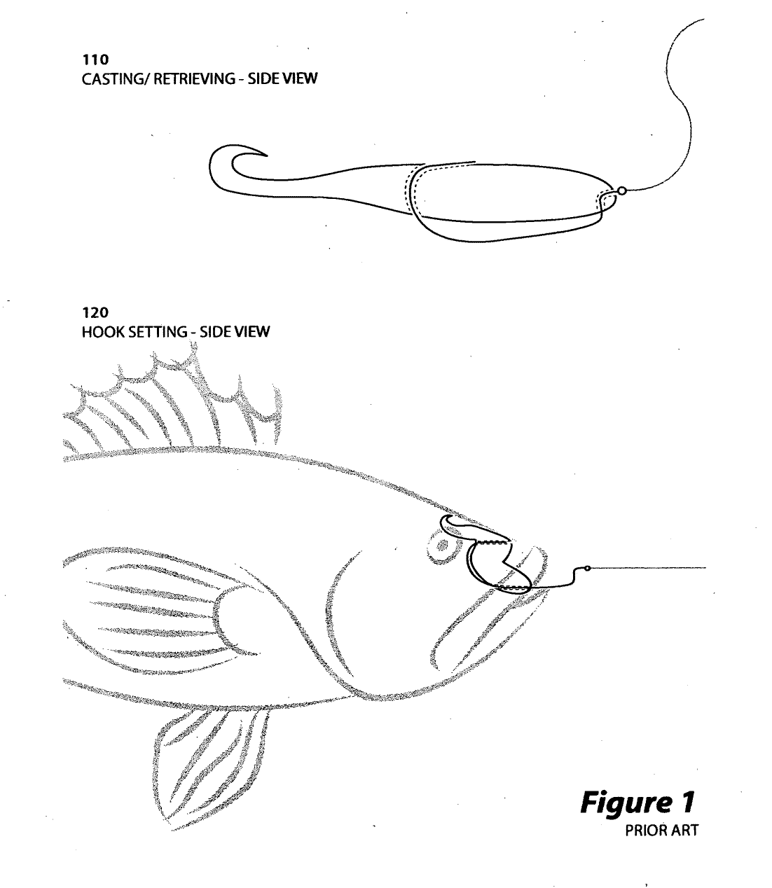

FIG. 1 conceptually illustrates an example of lures currently on the market with poor hook setting ratios. In this figure, the fishing lure is shown in the casting/retrieving side view 110 and a hook setting side view 120.

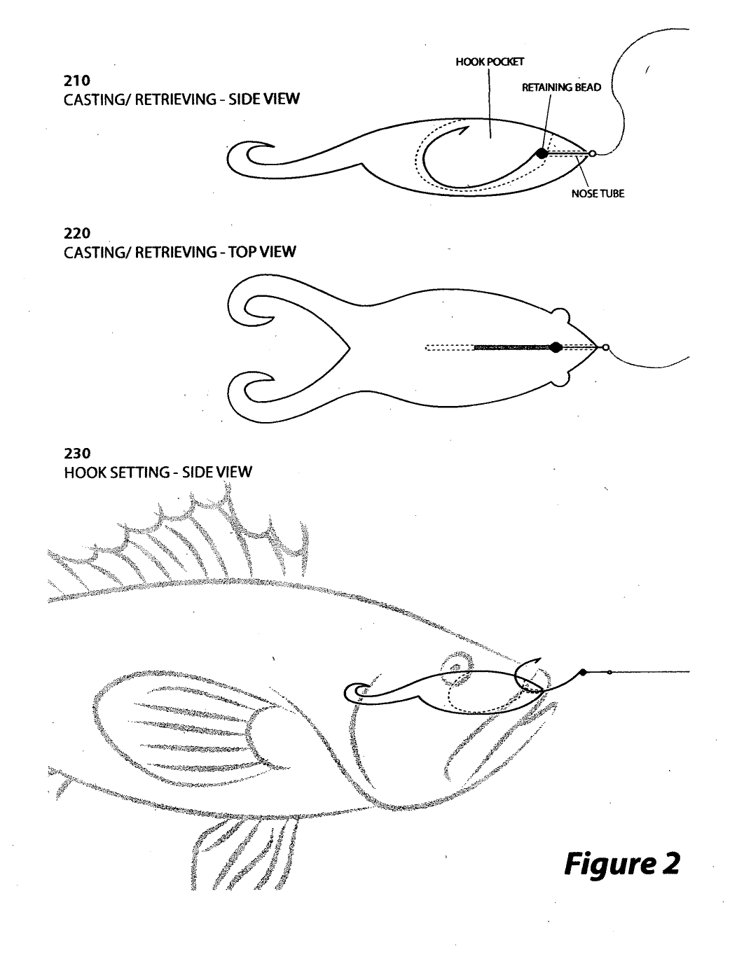

FIG. 2 conceptually illustrates the proposed fishing lure that increases the ratio of positive hook settings in some embodiments. In this figure, the fishing lure is shown in a casting/retrieving side view 210 and a casting/retrieving top view 220, and in a hook setting side view 230 when the hook is set in the mouth of a fish.

In the casting/retrieving side view 210, the fishing lure is shown in a pre-hook setting configuration with the hook and retaining bead loaded in the interior hook pocket. As shown, the nose tube is narrower than the retaining bead, and thus, the hook is partially locked in the interior hook pocket of the fishing lure.

The casting/retrieving top view 220 also illustrates the fishing lure in the pre-hook setting configuration. In the top view 220, the retaining bead is shown at the interior end of the nose tube. In this view, the retaining bead is illustrated as being slightly larger in width than the width of the nose tube. Thus, the hook is held in place within the interior hook pocket by the difference in width between the retaining bead and the nose tube.

In some embodiments, the width of the nose tube can be changed to make it easier or harder to pull the hook out of the semi-locked position inside the interior hook pocket. In other embodiments, the width of the retaining bead can be changed to increase or decrease the amount of force necessary to pull the retaining bead through the nose tube. Thus, the hook stays loaded in the interior hook pocket until sufficient force is applied to pull the retaining bead through the nose tube with the hook point moving out of and away from the lure body. In some cases, the dimensions of the retaining bead and/or nose tube are set so that a counteracting force must hold the fishing lure while the fish line is pulled taught For example, when the angler reels in the line or pulls up on the rod, the retaining bead will not be pulled through the nose tube unless a fish is biting the fishing lure, resulting in sufficient counteracting force to hold the fishing lure while the line is pulled taught

The hook setting side view 230 shows the fishing lure as the hook is being set. As shown, when the line is pulled against a counteracting force the retaining bead gets pulled through the nose tube and the hook is pulled out of and away from the lure body and into the mouth of the fish, while the body of the fishing lure remains in place behind the closed mouth of the fish and does not obstruct the hook set pathway.

As explained above, if no fish is biting the fishing lure, the fishing line can be pulled taught but the hook will not be pulled out of the interior hook pocket because the fishing lure requires a sufficient amount of counter force to initiate hook setting when the fishing line is pulled taught. Thus, the dimensions of the nose tube and the retaining bead width are able to increase and decrease the required amount of counter force to initiate the hook setting. In this way, an angler can freely retrieve the lure through weeds, brush, and other detritus in the water without initiating the hook setting.

In some embodiments, the fishing lure is weighted. The weighted fishing lure of some embodiments comprises a lure body, a hook with an attached retaining weight. The lure body of some embodiments comprises an interior hook pocket and a weight pocket. The hook set pathway comprises a first set of hook loading locations comprising the interior hook pocket of the lure body for the hook and the weight pocket for the retainer weight and a second set of hook setting locations comprising any of a plurality of locations protruding out from the lure body when setting the hook to the mouth of the fish.

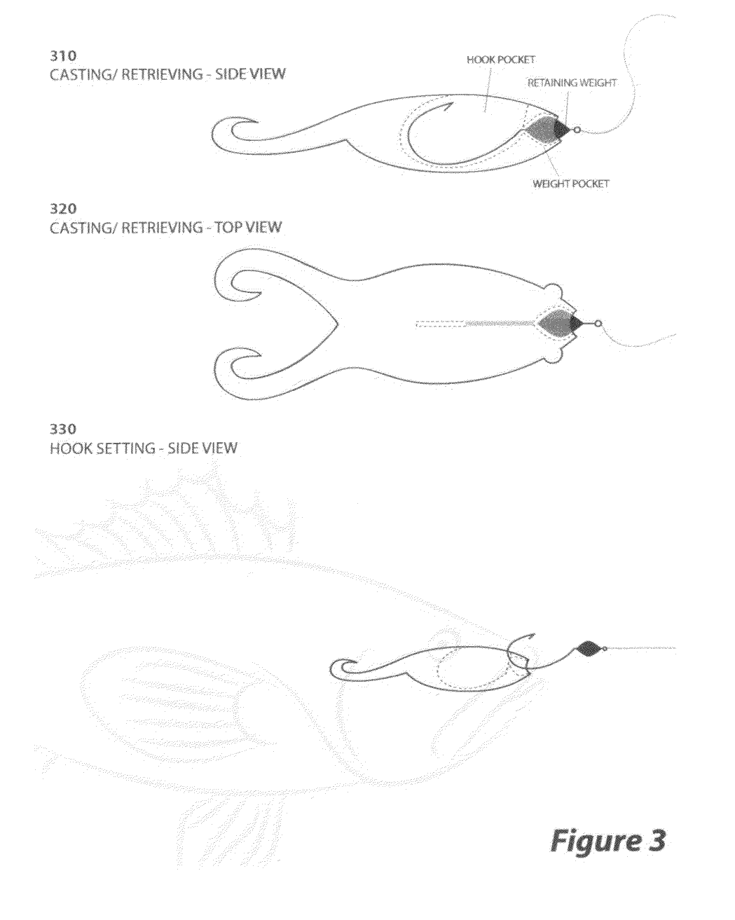

FIG. 3 conceptually illustrates the proposed weighted fishing lure of some embodiments. FIG. 3 illustrates the fishing lure described by reference to FIG. 2, with an adapted configuration to include a weight to the fish hook. FIG. 3 illustrates the weighted fishing lure in a casting/retrieving side view 310 and a casting/retrieving top view 320 prior to setting the hook in the mouth of a fish, and in a hook setting side view 330 when the hook is set in the mouth of a fish.

In the casting/retrieving side view 310, the weighted fishing lure is shown with the hook loaded in the interior hook pocket and the retaining weight partially locked in the weight pocket. The casting/retrieving top view 320 also illustrates the weighted fishing lure in the casting/retrieving configuration. In the casting/retrieving top view 320, the retainer weight is shown slightly breaching the fishing lure and is proximate to a position at which the fishing line is tied to the hook. Thus, the weight is front loaded in the fishing lure so that when the fish line is pulled taught against a counteracting force the retainer weight is pulled out of the semi-locked position in the weight pocket, with the hook following up out of and away from the lure body.

The side hook setting view 330 illustrates the weighted fishing lure when the hook is being set. As shown, when the line is pulled against a counteracting force, the retainer weight is released from the semi-locked position in the weight pocket, the hook also gets pulled out of the interior hook pocket. The hook protrudes unobstructed from the fishing lure to then set into the mouth of a fish.

However, as explained above by reference to FIG. 2 if no fish is biting the lure, the fish line can be pulled taught but will not be released from the semi-locked position in the weight pocket because the fishing lure requires a counter force to act when the fish line is pulled taught. Otherwise, without a counteracting force to hold the fishing lure, the lure will simply follow the path in which the line is being retrieved.

The above-described embodiments of the invention are presented for purposes of illustration and not of limitation.

I claim:

1. A fishing lure that reduces obstructions in order to increase the ratio of positive hook settings, the fishing lure connected to a fishing line and comprising:
a soft plastic lure body comprising an interior hook pocket and a nose tube;
a hook that resides in the interior hook pocket prior to initiating hook setting and protrudes from the lure body after initiating hook setting; and
a retaining bead, attached to the hook, that resides in the interior hook pocket at an interior opening of the nose tube, said retaining bead having a greater width than the width of the nose tube, wherein the hook is moved to the protruding position when the amount of force applied to the fishing line is sufficient to overcome a resistive force holding the retaining bead in the interior hook pocket, said resistive force based on the difference between the retaining bead width and nose tube width.
